(19) United States
(12) Patent Application Publication
(10) Pub. No.: US 2024/0215567 A1
(43) Pub. Date: Jul. 4, 2024

(54) COMPOSITIONS AND METHODS FOR PRESERVATION OF CADAVERS USED FOR SURGICAL TRAINING

(71) Applicant: GREEN SOLUTIONS GROUP, LLC, SALISBURY, NC (US)

(72) Inventor: LARRY D. KENNEDY, SALISBURY, NC (US)

(21) Appl. No.: 18/404,308

(22) Filed: Jan. 4, 2024

Related U.S. Application Data
(63) Continuation of application No. PCT/US24/10267, filed on Jan. 4, 2024.
(60) Provisional application No. 63/478,441, filed on Jan. 4, 2023.

(51) Int. Cl. A01N 1/02; G09B 23/28

(52) U.S. Cl. CPC A01N 1/021; G09B 23/285

(57) ABSTRACT

The present inventive concept provides non-toxic compositions including ethanol, a stabilizing agent, a solvent and an alkalinizing agent and methods of using the same in the field of preservation of a human cadaver for surgical training in general surgery, laparoscopic surgery, and/or robotically assisted surgery. In particular, the compositions provide a safer alternative to aldehyde-based compositions and fresh frozen cadavers. The present inventive concept also includes human cadavers for use during surgical training.

### CROSS-REFERENCE TO RELATED APPLICATIONS

The present application claims the benefit of U.S. Provisional Patent Application No. 63/478,441 filed Jan. 4, 2023, and is a bypass continuation application of International Application No. PCT/US24/10267 filed Jan. 4, 2024, the disclosures of which are incorporated herein by reference in their entireties.

### COPYRIGHT

This disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD

The present inventive concept relates to compositions and methods useful in the field of preservation of cadavers, particularly human cadavers, used to educate medical professionals in surgery techniques aimed at improving and making surgical procedures safer in all surgery specialties. More particularly, the present inventive concept relates to non-toxic compositions used to preserve human cadavers for use in general surgery, laparoscopic surgery, and/or robotically assisted surgery, and the cadavers provided through the use of the compositions.

### BACKGROUND

During the training of any medical professional or premedical student, hands-on training is essential. The standard for such training has been the use of lightly preserved human cadavers with formaldehyde and the use of fresh frozen tissue. The risks associated with the use of fresh frozen human tissue is the exposure of blood borne pathogens, specifically, different viruses (HIV, Hepatitis A, B, and C, and SARS-Covid-19).

Nevertheless, physicians of surgical training have placed significant reliance on fresh frozen human tissue. Bodies that are donated for scientific study are washed and frozen to −20° C. within a week of procurement. The majority of donors used for surgical training by hospital groups and medical device companies are dismembered and frozen body parts (torso, leg, arm, head, shoulder, etc.) are shipped to a location where the surgical training event will be hosted. Once received, the body parts are thawed at room temperature prior to use in surgical training. Fresh frozen cadavers provide better anatomy, normal tissue consistency and a realistic operative training experience compared to cadavers lightly preserved with formaldehyde and other toxic chemicals. The downside to using fresh frozen cadavers is the body can only be used for a relatively short time period, normally one to three days as decomposition starts immediately once the body is thawed.

Human anatomical models are used for surgical training. However, there is not any model or training device that includes the necessary level of detail to a human body, especially the aspects of human tissue, and the functionality of systems of the human body necessary for effective and realistic training. It is difficult to replicate human tissue at a level at which the final product functions like the human body. Surgical training for doctors is a complex and lengthy process because the learning curve is so long. A surgical resident must spend years in training because an apprentice surgeon only master's a surgical procedure after having done it many times, usually in excess of 25-50 times or more. Many surgical trainees currently generally practice on live patients in the operating room due to insufficient alternatives. This could lead to less-than-ideal patient outcomes and unnecessarily increased operation times. Studies have shown that longer operating times add to patient risk and increase the cost of care.

Moreover, the use of formaldehyde in the workplace has become subject to regulation where formaldehyde has been deemed a probable human carcinogen. Governmental regulatory authorities such as the U.S. Department of Labor, Occupational Safety and Health Administration (OSHA), the Environmental Protection Agency (EPA), etc. have placed various limits on workplace formaldehyde vapor exposure.

Workers in the medical field, which includes surgeons, doctors, fellows, nurses, forensic pathologists, embalmers, coroners, researchers, and interns are constantly exposed to high concentrations of formaldehyde vapors ranging from 25% to near saturation in water of around 40% during surgical training. Repeated exposure to formaldehyde vapors has been associated with carcinogenesis in laboratory animals (e.g., epitheliomas, nasopharyngeal cancer), owing wholly or in part to environmental formaldehyde vapor exposure in surgical settings.

There is a great need in the medical field for an effective, economical, and non-toxic tissue preservative to be used in preparing cadavers for surgical training.

### SUMMARY

The present inventive concept provides compositions and methods for safer, effective, and economical alternatives to using lightly embalmed cadavers with formaldehyde and/or the use of fresh frozen tissue in surgical training. The present inventive concept is far superior to lightly preserved cadavers or where fresh frozen tissue is used in surgical training. This non-toxic surgical training fluid (STF) preserves human tissue to a lifelike state with near perfect anatomy, normal tissue coloration and consistency, great flexibility, and the cadavers can be repurposed for multiple training and teaching sessions, optimizing their use in surgical training by enabling a surgeon or medical student to learn surgical approaches for a particular procedure before performing the procedure on a live patient. In general, the present inventive concept replicates what a surgeon would experience in the operating room thereby making the surgical training as realistic as possible. Specifically, donors preserved with this STF can last at least 8-10 weeks. Moreover, a method to revascularize the cadaver by introducing a proprietary blood substitute where there is a fluid exchange at the capillary level allows the cadaver to bleed during surgical procedures.

In particular embodiments, the present inventive concept provides a surgical training fluid that is a tissue preservative including ethanol, a stabilizing agent, a solvent, and an alkalinizing agent. In some embodiments, the surgical training fluid is essentially free of an aldehyde. In further embodiments, the surgical training fluid is non-toxic and/or environmentally safe. In some embodiments, the surgical training fluid includes an aqueous solution including ethanol, a humectant, an acid, a polar aprotic solvent, and a chelating agent.

Further embodiments of the inventive concept provide a method of embalming a body or anatomical part thereof, including administering into the body or anatomical part thereof a surgical training fluid tissue preservative composition as described herein.

The present inventive concept also provides a surgical training system that includes a cadaver and a simulated bodily fluid supply mechanism to provide a simulated bodily fluid.

Moreover, the present inventive concept provides kits that include an assembly of packaged preservative compositions along with packaged non-toxic pre-injection fluids that enhance the embalming process by dissolving coagulated blood in the vascular system prior to embalming the specimen for use in surgical training.

The present inventive concept also provides cadavers that are more life-like in comparison to formaldehyde-treated cadavers or fresh frozen tissue.

### DETAILED DESCRIPTION

The foregoing and other aspects of the present inventive concept will now be described in more detail with respect to other embodiments described herein. It should be appreciated that the inventive concept can be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention pertains. The terminology used in the description of the invention herein is for the purpose of describing embodiments only and is not intended to be limiting of the invention. As used in the description of the invention and the claims set forth herein, the singular forms “a,” “an,” and “the” are intended to include the plural forms as well, unless the context clearly indicates otherwise. As used herein, the term “and/or” includes all combinations of one or more of the associated listed items.

All publications, patent applications, patents and other references cited herein are incorporated by reference in their entireties for the teachings relevant to the sentence and/or paragraph in which the reference is presented.

The term “comprising,” which is used interchangeably with “including,” “containing,” or “characterized by,” is inclusive or open-ended language and does not exclude additional, unrecited elements or method steps. The phrase “consisting of” excludes any element, step, or ingredient not specified in the claim. The phrase “consisting essentially of” limits the scope of a claim to the specified materials or steps and those that do not materially affect the basic and novel characteristics of the claimed invention. The present disclosure contemplates embodiments of the inventive concept corresponding to the scope of each of these phrases. Thus, various embodiments of the presently disclosed compositions and methods may “comprise,” “consist” or “consist essentially of” the components, ingredients or steps disclosed herein.

Embodiments of the present inventive concept provide compositions that serve to disinfect and preserve the body, or parts thereof, in accordance with the desires of those practicing in the surgical training field. In particular embodiments, the compositions provide soft-cure embalming solutions. The present inventive concept further relates to non-toxic compositions used to preserve human and/or animal cadavers for use in general surgery, laparoscopic surgery, and/or robotically assisted surgery. plastic surgery, laparoscopic surgery, colon/rectal surgery, neurosurgery, critical care surgery, obstetrical/gynecological surgery, ophthalmology, otolaryngology, pediatric surgery, surgical oncology, orthopedic surgery, urological surgery, vascular surgery, and thoracic surgery within the medical or veterinary field.

Particular embodiments of the present inventive concept provide a surgical training fluid tissue preservative comprising, consisting essentially of, or consisting of ethanol, a stabilizing agent, a solvent and an alkalinizing agent. In some other embodiments, ethanol, a polymer, and a polar aprotic solvent. Ethanol used in the present inventive concept is specially formulated and not substituted with other alcohols such as isopropyl alcohol, glycerol, and methanol. Specially formulated ethanol in the present inventive concept is described as a grade approved by the FDA that is safe for humans that can have medical applications as an antiseptic and/or disinfectant, a chemical solvent for scientific chemical testing or in synthesis of other organic compounds and can be used across many kinds of manufacturing industries. In the present inventive concept, ethanol serves as a solvent, preservative, and/or a bactericidal agent. Ethanol is considered a universal solvent, as its molecular structure allows for the dissolving of both polar, hydrophilic, and nonpolar, hydrophobic compounds. As a preservative, ethanol begins to denature intracellular proteins by dehydration and coagulation. This is a noted first step in the preservation process, for upon denaturation of intracellular proteins the natural autolytic (decaying) process is arrested. Stabilization of tissues is completed by the action of ethanol. As a bactericide, ethanol kills microorganisms by dissolving their membrane lipid bilayer and denaturing their proteins and is effective against most bacteria, fungi, and viruses. Stabilizers included herein may be aromatic ethers such as phenoxyethanol. Alkalinizing agents included herein may be sodium salts of citric acid such as monosodium citrate, disodium citrate, and sodium (trisodium) citrate.

In some embodiments, the surgical training fluid tissue preservative is essentially free of an aldehyde. In other embodiments, the surgical training fluid tissue preservative is essentially free of formaldehyde, formalin, formic aldehyde, glutaraldehyde, methanol, methanediol, methanal, methyl aldehyde, methylene glycol and/or methylene oxide.

As used herein, “essentially free” or “substantially free” generally refers to a level considered to be a trace amount or background level. Such levels do not cause material harm that may be associated with the agent. In particular embodiments, essentially free refers to the presence of an aldehyde, formaldehyde, formalin, formic aldehyde, glutaraldehyde, methanol, methanediol, methanal, methyl aldehyde, methylene glycol and/or methylene oxide at a concentration of about 0.010% or less or optionally about 0.001% or less. In particular embodiments of the present inventive concept, compositions described herein do not contain any aldehydes, formaldehyde, formalin, formic aldehyde, glutaraldehyde, methanol, methanediol, methanal, methyl aldehyde, methylene glycol and/or methylene oxide.

Polymers that may be optionally included in the compositions described herein generally include, but are not limited to, homopolymers, copolymers, such as for example, block, graft, random and alternating copolymers, terpolymers, etc., and blends and modifications thereof. Suitable polymers include propylene glycol, diethylene glycol, dipropylene glycol, polyethylene glycol, 1,3-propanediol, ethylene glycol, and combinations thereof. The polymers may have a molecular weight from about 5,000 to about 10,000. In particular embodiments, the polymer is propylene glycol.

Polar aprotic solvents that may be optionally included in the compositions described herein generally include, but are not limited to, isopropyl ethyl acetate, dichloromethane, tetrahydrofuran, ethyl acetate, dimethylformamide, acetonitrile and combinations thereof. In particular embodiments, the polar aprotic solvent is isopropyl ethyl acetate.

According to additional embodiments of the present inventive concept, the surgical training fluid tissue preservative may also include a surfactant, a buffer, distilled or de-ionized water, a humectant, an antimicrobial agent, a chelating agent, a fragrance, an anticoagulant, an emollient and/or a color additive.

Surfactants that may be optionally used in the present inventive concept are generally anionic surfactants. Exemplary anionic surfactants include alkyl ether sulfates, benzyl sulfonates, and phosphate esters. Suitable anionic surfactants for use herein include sodium dodecyl sulfate (SDS), sodium lauryl sulfate (SLS), sodium laureth sulfate (SLES), ammonium lauryl sulfate (ALS), ammonium laureth sulfate (ALES), sodium stearate and potassium cocoate. In particular embodiments, the anionic surfactant is sodium dodecyl sulfate.

As used herein, a buffer is an agent used to maintain the pH of a composition near a chosen value. Buffers are well known to those skilled in the art. A buffer may be optionally included. In particular embodiments, addition of approximately 4 grams acid sodium phosphate monohydrate and 6.5 grams disodium phosphate (anhydrous) per liter of solution generally is effective as a buffer for the present inventive concept.

As used herein, “water” may refer to potable water, tap water, distilled water, demineralized water, or de-ionized water. In particular embodiments, the compositions are provided as aqueous solutions in distilled or de-ionized water.

Humectants used in the present inventive concept help to counter effects of dehydration. Suitable humectants include, but are not limited to, glycerine (glycerol), ethylene glycol, propylene glycol, mannitol, and sorbitol. In particular embodiments, the humectant is propylene glycol and/or glycerine.

Antimicrobial agents used in the present inventive concept are used to destroy microorganisms or to prevent their development. Antimicrobial agents include bactericides, germicides, viricides, fungicides, biocides, and sporicidals. In some embodiments, the antimicrobial agent includes aldehydes, halogens, and quaternary ammonium compounds. In particular embodiments, the antimicrobial agent includes ethanol, onyxide 500, hydantoin, phenoxyethanol and mixtures thereof.

Chelating agents or chelants, chelators, or sequestering agents may be included to react with metal ions to form a stable, water-soluble complex to assist with preservation. Suitable chelating agents include, but are not limited to, pyrophosphoric acid, tripolyphosphoric acid, citric acid, tartaric acid, and glycine. In particular embodiments, the chelating agent is EDTA, or a salt thereof.

Fragrances (or perfumes) included in the tissue preservative described herein include fragrances that are non-toxic and can be organic, natural, or synthetic and include essential oils. Eucalyptus, lavender, sandalwood, juniper berries, vanilla, lemon, mint, black currant, amber, peony, black violet, saffron, chrysanthemum, freesia, geranium and rose are non-toxic fragrances suitable for use in the compositions described herein.

An emollient may be used to soften the skin. Suitable emollients include, but are not limited to, castor oil, cetyl alcohol, isopropyl myristate, stearic acid, stearyl alcohol, glycerin, propylene glycol, phenoxyethanol, and mineral oil.

A color additive (or coloring agent) included in the tissue preservative described herein includes any non-toxic dye, pigment or substance that imparts color to the tissue preservative. Suitable color additives include, but are not limited to, tetrabromofluorescein (eosin Y), zinc oxide, titanium dioxide, sericite, hematite, goethite, and lepidocrocite.

Anticoagulants are used to dissolve coagulated blood in the vascular system. Anticoagulants are chemical substances that chelate (bind) calcium ions, preventing blood from clotting. The most common anticoagulants are coumarins and heparins (sodium citrate, acid-citrate dextrose, oxalate, warfarin, acenocoumarol, phenprocoumon, and atromentin. In particular embodiments, the anticoagulant used is EDTA and sodium citrate.

According to further embodiments of the present inventive concept, the surgical training fluid tissue preservative is an aqueous solution. The tissue preservative may also be non-toxic, biodegradable and/or environmentally safe.

Non-toxic refers to minimum risk in normal use. In particular embodiments, the exposure to the substance during the normal course of usage does not result in harmful and/or irreversible side effects to humans and/or the environment. Such side effects to humans may include, but are not limited to, eye, skin, respiratory, reproductive, and nervous system disorders, diseases, etc. Another indicator of non-toxicity is the designation “generally regarded as safe” or GRAS by the United States Food and Drug Administration. These ingredients may not meet usual test criteria for safety but have been extensively used and have not demonstrated any harm to consumers. Moreover, as used herein, the term “non-toxic” is intended to convey a composition that, while effective in preserving tissue as described herein, is safe to use around humans and/or if found in the environment.

Environmentally safe”, “environmentally compatible” “environmentally preferred”, “environmentally friendly”, or “green”, as used herein refer to the quality of not being harmful to plants and/or animals when exposure is under normal conditions or deemed to inflict reduced, minimal, or no harm upon ecosystems and/or the environment.

The term “biodegradable” or “degradable” generally refers to a substance that degrades from the action of naturally occurring microorganisms, such as bacteria, fungi, and algae; environmental heat; moisture; or other environmental factors, such as determined testing methods according to testing standards from guidance organizations such as the Environmental Protection Agency (EPA), Organisation for Economic Co-operation and Development (OECD), American Society for Testing and Materials (ASTM), International Organization for Standardization (ISO), etc.

Embodiments of the present inventive concept also include a non-toxic surgical training fluid tissue preservative including an aqueous solution including ethanol, a humectant, an acid, a polar aprotic solvent, and a chelating agent. Suitable acids include, but are not limited to, ethanoic acid, citric acid, glycolic acid, and pyruvic acid. In particular embodiments, the acid is ethanoic acid.

The present inventive concept further provides methods of embalming a body or anatomical part thereof, including administering into the body or anatomical part thereof the surgical training fluid tissue preservative described herein. The method may also include administering the surgical training fluid tissue preservative into the circulatory system of the body. The method may also include administering the tissue preservative into the peritoneal and/or thoracic cavity of the body. These steps may be carried out simultaneously or sequentially. The body or anatomical part thereof can be a human body or an animal body. In some embodiments, the body or anatomical body is a human body or anatomical part thereof for dissection and/or surgical training.

The present inventive concept also provides a surgical training system that includes a cadaver or anatomical part thereof and a simulated bodily fluid supply mechanism to provide a simulated bodily fluid. The simulated bodily fluid supply mechanism can range from a sophisticated apparatus such as pumps and circulators to a simple apparatus such as a syringe. The simulated bodily fluid can include one of blood, urine, organ fluid, cerebrospinal fluid, synovial fluid, mucus, semen, tears and/or saliva. In some cases, the fluid may be an actual bodily fluid.

Embodiments of the present inventive concept also include kits for preparation of a subject, specimen, or anatomical part thereof for surgical training. The kit includes specific containers of the compositions described herein along with a pre-injection fluid. The term “pre-injection” fluid is used herein to denote a non-toxic formulation that is typically administered into the circulatory system of a human body, as an initial part of the embalming process, prior to the injection of the major tissue preservative. The major role of the pre-injection fluid is to clear other obstructions and clots from the circulatory system (primarily the vascular system), although the pre-injection fluid can have some tissue preservation and disinfecting properties. In some embodiments, the pre-injection fluid comprises ethanol, a humectant, a surfactant, a germicidal or biocidal agent, an anticoagulant, and optionally a colorizing agent. See U.S. Pat. No. 11,382,326. Instructions for the use of the components of the kit are also included and/or a quick response (QR) code, link, or other digital reference thereto is provided.

Benefits of the compositions and methods of the present inventive concept include, but are not limited to, elimination of being exposed to a human carcinogen, not having a suffocating and/or pungent odor; not causing irritation to the nose and/or throat; not causing nausea and headache; does not cause itching, burning, drying, and/or scaling of skin; is not a serious respiratory irritant; does not cause coughing, wheezing, and/or shortness of breath; eliminates disposal costs of hazardous waste; is easy to store; is easy to dispose; and is safe to transport. Additionally, bodies embalmed with the compositions described herein function more like a body in a life-like state compared to a body preserved with formaldehyde. For example, cadavers preserved with the surgical training fluid described herein present tissue color that reflects clinical reality, and nerves, vessels, and tendons retain elasticity, and thus, exhibit reduced tearing and breakage.

As a result of the benefits of using the compositions and methods described herein, the present inventive concept also provides a superior human or animal cadaver for surgical training. The cadaver is prepared by administering to a body a composition as described herein. The cadaver prepared using the surgical training fluid compositions described herein can be manipulated as if life-like and/or can be used for up to 8-10 weeks, i.e., twenty times longer than using fresh frozen tissue. The cadavers of the present inventive concept can also be repurposed in contrast to fresh frozen tissue.

Some aspects of the present inventive concept are described in more detail in the following non-limiting examples.

### EXAMPLES

The following examples have been included to provide guidance to one of ordinary skill in the art for practicing representative embodiments of the presently disclosed subject matter. Considering the present disclosure and the general level of skill in the art, those of skill can appreciate that the following examples are intended to be exemplary only and that numerous changes, modifications, and alterations can be employed without departing from the scope of the presently disclosed subject matter.

Embalming Protocol using the Non-toxic Surgical Training Fluid (STF) of the present inventive concept. In the present example, embalming a surgical training donor is a 3-step process as described herein. Prior to beginning the embalming process, ensure the cadaver is taken from the cooler and allowed to thaw to room temperature. Selection of the donor is critical. It is recommended the donor weight not exceed 150 pounds. Ideally, the donor should have a BMI under 27 with no pathologies that would limit distribution and diffusion of the fluid, and no damage to the anatomical structures for surgical training. Cadavers prepared using the present STF can be repurposed for additional surgical training sessions versus a one-session training from using a fresh frozen cadaver, the current industry standard.

The first step in preparing a surgical training cadaver is to clear coagulated blood from the vascular system. It is recommended to use GreenMBalm™ non-toxic Pre-Injection Fluid (PIF) (See U.S. Pat. No. 11,382,326) to flush coagulated blood from the vascular system. This is accomplished by mixing one (1) 16 oz. bottle of PIF with one gallon of water. It is recommended to use a total of three (3) 16 oz. bottles with three gallons of water as the pre-injection flush. When proceeding with this procedure, a single-point injection method is preferred by injecting 2 of the 3-gallons of PIF into the carotid artery at 40 PSI and about 15-20 oz/min (600 ml/min) and the fluid enters into the circulatory system and the system is closed, the vein should not be opened for drainage, no other vessel should be isolated nor cannulated. Adjust flow as needed in order to see proper vascular distention in the superficial vasculature (through the skin). It is recommended to let the PIF remain in the closed system for approximately 45 minutes.

The second step in the process is to preserve the human brain. Drill a small hole in the superior sagittal sinus and use a drill bit that is rated for metal, and clear hair and tissue from the drilling area to ensure that the bit does not get tangled while you are working. Upon completion of drilling the hole, use a hypodermic needle and inject approximately 48 cc's of GreenMBalm™ long-term anatomical preservation fluid directly into the brain. This will preserve the brain for long-term use.

Another method to preserve the brain is to introduce a cannula into the opening and injecting the brain using the embalming machine. Set the pressure to about 10 PSI and flow to about 5 oz/min. Inject, remove the cannula, allow fluid to drain out of the hole, and continue to do this until there is no longer blood in the returning fluid. In this method, you will use approximately 8-16 oz of GreenMBalm™ long-term anatomical preservation fluid. Close the drill hole with a trocar button to allow the brain to profuse with the fluid or elevate the donor's head to allow gravity to keep the fluid inside of the cranium. After the cadaver is finished being used for surgical training, the brain can be extracted from the cranial case and be used for pro-section.

The third step is to allow for as much of the PIF and blood to drain from the cadaver prior to embalming. This is accomplished by opening the closed system and introducing pressure from the embalming machine to flush the PIF from the cadaver. While injecting the final gallon of PIF, open the jugular vein to encourage draining of as much blood as possible. Once the final gallon is injected, allow the donor to sit until the drainage has stopped, re-close the system by ligating or clamping the jugular vein. Proceed with the embalming process by injecting 4-gallons of GSG's ready to use STF fluid. The viscosity of the STF is such that it will penetrate the tissues much faster than standard embalming but will not give the same “tell-tale” signs of completion that you get with formaldehyde. Rather than looking for firming of tissues, look for fullness of tissues. The size of the body will increase throughout injection, leading to a feeling of fullness in the tissues. This will be the main indicator that you are getting proper distribution and diffusion of the STF.

Upon completion of the embalming process, allow the donor to sit for 1-2 weeks, if possible before using it for surgical training. The longer the donor is allowed to cure, the better the preservation will be. The results are different than standard formaldehyde embalmed donors. There is a considerable increase in the pliability of the tissues, as well as retained tissue coloration. Seeing red muscles, and properly colored organs does not mean they are not preserved. It is simply one of the benefits of the STF solution. This embalming process uses only non-toxic chemicals to preserve surgical training cadavers.

Approximately 25-30 human cadavers have been embalmed and used in surgical training events at medical schools, hospital groups, and medical device companies located in the US. All cadavers were embalmed using the protocol listed above and the STF preserved human tissue to a life-like state with near perfect anatomy and normal tissue coloration and consistency in all cadavers. After the embalming process, the cadavers were used for (1) airway training, (2) emergency medicine training, and (3) general surgery training and (4) laparoscopic surgery. The following surgical procedures were successfully performed on donors preserved with the STF described herein: Cricothyrotomy, Lateral Canthotomy, Chest Tube (open and percutaneous), central line access (subclavian and femoral), arthrocentesis of elbow, thoracotomy with incision into the pericardium, skull base dissection, total knee replacement, abdominal wall hernia repair, HPB liver resection, aortic arch replacement, soleus flap, osteotomy, distal pancreatectomy/splenectomy, cholecystectomy, intubation, pelvic floor exploration (in high lithotomy position), interposition reversed arm vein grafting, ultrasound guided injections (sleep apnea device insertion), flap reconstructive plastic surgery, lumbar puncture, craniotomy, and gastrojejunostomy. The cadavers were able to be successfully insufflated and laparoscopic surgical procedures performed on the cadavers.

Charged Cadavers. Methods of the present inventive concept also include methods wherein the circulatory system is charged, and a proprietary solution is introduced to the system that simulates blood, making the surgical experience even more realistic. In order to accomplish this, once embalming has been completed, keep the embalming cannulas secured in the carotid artery (or artery of your choice). Re-opening the jugular vein and insertion of a drainage tube are advised. The drain tube should be connected to a drainage hose, which should empty into a 5-gallon carboy, which can be used for waste removal after the session. Mix 3-gallons of the present recharge fluid into the electric embalming machine. Set the pressure to about 20 PSI and set flow to med-low or about 15-20 oz/min (600 ml/min) (you may increase flow to proper vascular distention) and then set flow to the pulse setting. Keep drain tube closed until the vasculature has distended and open drain tube to allow the release of some vascular pressure as needed. The machine may continue to run or it may be turned on only during the procedures.

This protocol is not achievable when the body has been embalmed with a formaldehyde and phenol solution, as the blood will harden, leaving vascular blockage and the vasculature dehydrates, making re-vascularization very difficult. This protocol is conducted optimally in conjunction with preservation with GreenMBalm™, as the vasculature remains elastic, and the proprietary formula hinders coagulation and vascular blockages.

Pathogen Testing. Preliminary studies show that compositions of the surgical training fluid exhibit a 99.95% reduction in Hepatitis A virus in 10 minutes with a 3.33 log reduction, and a 99.998% reduction in Coronavirus 229E virus in 2 minutes with a 4.79 log reduction.

The following table describes embodiments of an injectable tissue preservative composition of the present inventive concept designed for injection into the circulatory system of a human body as part of the embalming process for surgical training.

TABLE 1
Injectable Surgical Training Fluid Tissue Preservative Composition

| | |
|---|---|
| Ingredient | Composition Range |

Composition 1

| | | |
|---|---|---|
| a. | EtOH | 20.0%-50.0% |
| b. | Methyl Isobutyl Ketone | 0.00%-0.07% |
| c. | Isopropyl Ethyl Acetate | 0.00%-0.07% |
| d. | Tertiary Butyl Alcohol | 0.00%-0.05% |
| e. | Glycerine | 0.00%-1.20% |
| f. | Propylene Glycol | 0.00%-12.0% |
| g. | Onyxide 500 | 0.00%-0.08% |
| h. | Sodium Dodecyl Sulfate | 0.00%-1.20% |
| i. | Ethylenediamine Tetra-Acetic Acid | 0.00%-5.00% |
| j. | Hydantoin | 0.00%-20.0% |
| k. | Phenoxyethanol | 0.40%-20.0% |
| l. | Water | 30.0%-60.0% |
| m. | Sodium Citrate | 0.10%-15.0% |

Composition 2

| | | |
|---|---|---|
| a. | EtOH | 20.0%-50.0% |
| b. | Phenoxyethanol | 0.40%-20.0% |
| c. | Water | 30.0%-60.0% |
| d. | Sodium Citrate | 0.10%-15.0% |

In general, the present inventive concept provides an opportunity to simulate or replicate what a surgeon would experience in the operating room during surgery thereby making the surgical training experience as realistic as possible by providing preserved tissue to a life-like state having near perfect anatomy, normal tissue coloration, consistency, and mobility over an extended duration compared to the current industry standard of cold/frozen or formaldehyde-preserved cadavers and anatomical parts.

That which is claimed:

1. A surgical training fluid comprising ethanol, a stabilizing agent, a solvent and an alkalinizing agent.

2. The surgical training fluid of claim 1, wherein the surgical training fluid is essentially free of an aldehyde.

3. The surgical training fluid of claim 1, wherein the surgical training fluid is essentially free of formaldehyde, formalin, formic aldehyde, glutaraldehyde, methanol, methanediol, methanal, methyl aldehyde, methylene glycol and/or methylene oxide.

4. The surgical training fluid of claim 1, wherein the stabilizing agent is selected from the group consisting of propylene glycol, diethylene glycol, dipropylene glycol, polyethylene glycol, 1,3-propanediol, ethylene glycol, phenoxyethanol and combinations thereof.

5. The surgical training fluid of claim 1, wherein the solvent is water.

6. The surgical training fluid of claim 1, wherein the alkalinizing agent is a sodium salt of citric acid.

7. The surgical training fluid of claim 1 further comprising a humectant, an antimicrobial agent, a chelating agent, a fragrance, an emollient and/or a color additive.

8. The surgical training fluid of claim 7, wherein the humectant is propylene glycol and/or glycerine.

9. The surgical training fluid of claim 7, wherein the antimicrobial agent is ethanol, onyxide 500 and/or hydantoin.

10. The surgical training fluid of claim 7, wherein the chelating agent is EDTA, or a salt thereof.

11. The surgical training fluid of claim 1, wherein the surgical training fluid is an aqueous solution.

12. The surgical training fluid of claim 1, wherein the surgical training fluid is non-toxic and/or environmentally safe.

13. A method of preparing a body or anatomical part thereof for surgical training, the method comprising administering into the body or anatomical part thereof a surgical training fluid of claim 1.

14. A human cadaver or anatomical part thereof for use in surgical training prepared by administering into a human body or anatomical part thereof the surgical training fluid of claim 1.

15. The cadaver of claim 14, wherein the cadaver further comprises a simulated body fluid or a pre-injection fluid.

16. A method of performing surgical training comprising performing a surgical technique on a human cadaver or anatomical part thereof of claim 14.

17. The method of claim 16, wherein the surgical training technique is a general surgery, laparoscopic surgery, and/or robotically assisted surgery.

18. The method of claim 17, wherein a tissue operated upon during the surgical training technique is selected from brain, eye, heart, liver, stomach, intestines, pancreas, muscle, skin, bone, kidney, bladder, rectum, prostate, breast, cervix, lung, and/or ovary.

19. A surgical training system comprising:
(a) a human cadaver or anatomical part thereof of claim 14; and
(b) a simulated bodily fluid supply configured to provide a bodily fluid.

20. The surgical training system of claim 19, wherein the anatomical part is selected from an appendage and/or an articulated joint.

21. The surgical training system of claim 19, wherein the simulated bodily fluid is selected from simulated blood, urine, organ fluid, cerebrospinal fluid, synovial fluid, mucus, semen, tears and/or saliva.

22. A kit comprising:
(a) a surgical training fluid comprising ethanol, a stabilizing agent, a solvent and an alkalinizing agent;
(b) a pre-injection fluid; and
(c) instructions or digital reference thereto for use of the surgical training fluid and the pre-injection fluid to prepare a cadaver for preservation for use in surgical training.
